(19) United States
(12) Patent Application Publication
(10) Pub. No.: US 2011/0063330 A1
(43) Pub. Date: Mar. 17, 2011

(54) METHOD AND APPARATUS FOR REDUCING ERRONEOUS COLOR EFFECTS IN A FIELD SEQUENTIAL LIQUID CRYSTAL DISPLAY

(76) Inventors: Kwang Hee Bae, San Jose, CA (US); Sang Tae Lee, San Jose, CA (US); Chan Woo Jung, San Jose, CA (US)

(21) Appl. No.: 12/312,297

(22) PCT Filed: Nov. 8, 2008
(86) PCT No.: PCT/US2008/012561

§ 371 Date: May 5, 2009

Related U.S. Application Data
(60) Provisional application No. 61/002,848, filed on Nov. 13, 2007.

(51) Int. Cl. G09G 3/36; G09G 5/10

(52) U.S. Cl. 345/690; 345/88

(57) ABSTRACT

Methods and apparatuses for reducing an erroneous color effect in a field-sequential liquid crystal display (FSLCD) are disclosed. An apparatus for reducing the erroneous color effect may include a data response time compensation (RTC) block which uses an RTC lookup table to provide a fast transition response time from one gray level to another gray level for a liquid crystal pixel cell by using a response time compensation (RTC) scheme during a color LED backlighting sequence. The apparatus may also include a VCOM and Gamma reference control block to generate a voltage boost and provide boost control to the liquid crystal pixel cell in a FSLCD panel, wherein the voltage boost gives a fast gray level transition to remove residual color caused by a slow transition time between liquid crystal light transmittance levels for the liquid crystal pixel cell.

### BACKGROUND

In a variety of modern electronic devices, liquid crystal displays (LCD's) are becoming increasingly dominant and ubiquitous display of choice for visual applications. LCD's initially achieved its commercial success several decades ago as niche-market applications in electronic devices requiring monochrome visual panels, such as calculators, portable game devices, vehicle dashboard indicators, and/or other small display applications. The LCD technology has since evolved dramatically to enable higher-resolution, larger screen, and full-color mainstream applications cost effectively as a direct replacement of cathode ray tubes (CRT's). For example, color thin-film-transistor (TFT) LCD's are commonly used in today's mainstream electronics market as notebook computer screens, flat-panel televisions, large advertising panel displays, and smart cellular phone displays.

A typical color TFT LCD's has each pixel of the display subdivided into three primary color sub-pixels, which are red, green, and blue using color filters. Coordinating a desired color filter for each sub-pixel, varying a gray level of the sub-pixel of each pixel, and emitting a bright white backlight produces a desirable color effects on the typical color TFT LCD. Moving images or video display on a color TFT LCD requires a constant update of gray levels per frame, with each frame typically occupying 16.7 milliseconds (ms). Conventional types of color TFT LCD's include twisted nematic (TN), in-plane switching (IPS), vertical align (VA), and other variants. Gray level control is achieved for these conventional color TFT LCD's by controlling light “transmissivity” of each liquid crystal pixel cell. The light transmissivity of each liquid crystal pixel cell is related to an electrical charge deposited on each cell, and the electrical charge is controlled by a display driver integrated circuit (IC).

A different class of LCD technology, known as a field-sequential LCD (FSLCD), uses a different visual display concept compared to conventional color TFT LCD's with color filters. Instead of using color filters for sub-pixels of a liquid crystal pixel cell, the field-sequential LCD uses a monochrome TFT LCD with each liquid crystal pixel cell back-lighted by a particular color light-emitting diode (LED) in a rapid time sequence. The FSLCD, in theory, uses a rapid sequential backlighting of at least three primary colors LED's (i.e. red, green, and blue LED's) per monochrome liquid crystal pixel cell, wherein the rapid sequential backlighting is fast enough to make a human eye visualize color LED backlighting sequences as “mixed” colors (e.g. pink, purple, yellow, and etc.), as plain primary colors (i.e. red, green, blue), or as black or white colors. For a field-sequential LCD, a “frame”, which may be a 16.7 ms-time interval in a conventional color TFT LCD with color filters, is further subdivided into sub-frames, or “fields” of equal time intervals. For example, a frame of 16.7 ms can be subdivided into three fields of 5.55 ms in each field in a field-sequential LCD, wherein each field is used for one particular primary color LED emission and corresponding liquid crystal pixel response preparation.

The concept of field-sequential LCD relies on the fact that a human eye cannot distinctively detect sequential transmissions of primary color LED's in a specified individual frame (e.g. 16.7 ms) or a fraction thereof. The human eye instead senses the sequential transmissions of primary color LED's as mixed colors, as plain primary colors, or as black or white colors depending on a particular sequence of activated primary color LED's in a string of frames.

The field-sequential LCD has several advantages over the conventional color TFT LCD's with color filters. Because no color filters are necessary and each LED color backlighting is capable of passing through an entire liquid crystal pixel instead of just a sub-pixel fraction of a liquid crystal pixel, the field-sequential LCD has significantly higher light transmissivity and power savings relative to conventional color TFT LCD's. For example, compared to a conventional color TFT LCD which has three sub-pixels and color filters per liquid crystal pixel cell for three primary colors (i.e. red, green, and blue), a theoretical light transmissivity for a field-sequential LCD can be three times higher than the a theoretical light transmissivity of the conventional color TFT LCD.

However, the field-sequential LCD technology has not achieved commercial mass production stage yet due to some significant technical hurdles. A nagging issue with the field-sequential LCD technology is a technological hurdle for bringing electro-optic gray level, black-to-white, and white-to-black response times of a monochrome LCD pixel cell fast enough to coordinate with a timely transmission of a color LED backlight during a sub-frame (i.e. field) interval of a frame interval. For instance, a monochrome LCD pixel needs to have a response time fast enough to reach a desired light transmittance level at a moment when a particular color LED is emitting its backlighting color to the monochrome LCD pixel. Because each frame is subdivided into several time sub-frames or “fields” in a field-sequential LCD, and some fields in each frame are regularly used to light sequential backlighting colors, the response time requirement of the monochrome LCD pixel in the field-sequential LCD is significantly shorter and more rigorous than conventional color TFT LCD's. Commonly-used liquid crystal technologies such as twisted nematic (TN), in-plane switching (IPS), vertical align (VA), and other variants are not able to provide fast response times that can satisfy time sub-frame response requirement of field-sequential LCD's.

If an underlying response time of liquid crystal pixel cells is slower than the response time requirement in each sub-frame (i.e. field) of a frame of a field-sequential LCD, an erroneous color mixing can frequently occur on the display, which makes such field-sequential LCD's not commercially viable. The field-sequential LCD is currently in prototypes and small-volume limited productions using special liquid crystal materials with very fast response times, such as optically-compensated bend (OCB)-type liquid crystals. However, OCB-type liquid crystals are expensive relative to more mass-produced liquid crystal technologies such as twisted nematic (TN) liquid crystals, in-plane switching (IPS), vertical align (VA), and other variants. A lack of cost-effective solution for implementation of field-sequential LCD's has been a key obstacle to commercial mass production of field-sequential LCD's.

Therefore, it is highly advantageous to create a novel method and an apparatus to provide a cost-effective solution to satisfy the timing response requirement of liquid crystal pixel cells for a field-sequential LCD using commonly-used liquid crystal materials.

### SUMMARY

An apparatus for reducing an erroneous color effect in a field-sequential liquid crystal display (FSLCD) is disclosed as an embodiment of the present invention. The apparatus comprises a data response time compensation (RTC) block configured to receive sequential display signals, wherein the data RTC block is also configured to use an RTC lookup table to provide a fast transition response time from one gray level to another gray level for a liquid crystal pixel cell by using a response time compensation (RTC) scheme during a color LED backlighting sequence, a VCOM and Gamma reference control block configured to generate a voltage boost and provide boost control to the liquid crystal pixel cell in a FSLCD panel operatively connected to the VCOM and Gamma reference control block, wherein the voltage boost gives a fast gray level transition to remove residual color caused by a slow transition time between liquid crystal light transmittance levels for the liquid crystal pixel cell, and an output interface for the RTC block and/or the VCOM and Gamma reference control block, wherein the output interface is configured to transmit manipulated sequential display data from the RTC block and/or the output interface is configured to transmit a boosted voltage control signal from the VCOM and Gamma reference control block.

Furthermore, an apparatus for reducing an erroneous color effect in a field-sequential liquid crystal display (FSLCD) is also disclosed as another embodiment of the invention. This apparatus comprises a data response time compensation (RTC) block configured to receive sequential display signals, wherein the data RTC block is also configured to use an RTC lookup table to provide a fast transition response time from one gray level to another gray level for a liquid crystal pixel cell by using a response time compensation (RTC) scheme during a color LED backlighting sequence, and an output interface for the RTC block, wherein the output interface is configured to transmit manipulated sequential display data from the RTC block.

In addition, a method for reducing an erroneous color effect in a field-sequential liquid crystal display (FSLCD) is also disclosed as an embodiment of the invention. The method comprises steps of receiving one or more sequential display signals in a data response time compensation (RTC) block, accessing an RTC lookup table from the RTC block to retrieve an RTC gray level command value based on a previous gray level command value to a pixel and a current gray level command value to the pixel, generating one or more manipulated sequential display data using the RTC gray level command value, wherein the one or more manipulated sequential display data are eventually transmitted to the FSLCD, and generating one or more boosted VCOM voltage control signals and/or one or more Gamma reference voltage control signals to provide a fast gray level transition to remove residual color caused by an insufficiently-slow liquid crystal light transmittance level transition of the pixel, wherein the one or more boosted VCOM voltage control signals and/or one or more Gamma reference voltage control signals are eventually transmitted to the FSLCD.

### BRIEF DESCRIPTION OF DRAWINGS

FIG. 1 shows a conventional driver IC for a typical color TFT LCD with primary color filters.

FIG. 2 shows a novel driver IC for a field-sequential LCD (FSLCD) in accordance with an embodiment of the invention.

FIG. 3 shows a color sequential display data and control signal generator block in accordance with an embodiment of the invention.

FIG. 4 shows an example of relationships among pixel voltages, pixel light transmittance levels, primary color LED emitting timings, and resulting display patterns relative to time for a field-sequential LCD (FSLCD) in a theoretical ideal case.

FIG. 5 shows an example of relationships among pixel voltages, pixel light transmittance levels, primary color LED emitting timings, and resulting display patterns relative to time for a field-sequential LCD (FSLCD) in a realistic case without any response time compensation.

FIG. 6 shows an example of relationships among pixel voltages, pixel light transmittance levels, primary color LED emitting timings, and resulting display patterns relative to time for a field-sequential LCD (FSLCD) with a simple response time compensation (RTC) scheme in accordance with an embodiment of the invention.

FIG. 7 shows an example of relationships among pixel voltages, pixel light transmittance levels, primary color LED emitting timings, and resulting display patterns relative to time for a field-sequential LCD (FSLCD) with an advanced response time compensation (RTC) scheme in accordance with a preferred embodiment of the invention.

FIG. 8 shows an example of pixel voltages and driver IC VCOM and column voltages relative to time when a yellow color is displayed based on the example of FIG. 7, in accordance with an embodiment of the invention.

FIG. 9 shows various voltage levels in a field-sequential display (FSLCD) for a quick white-black transition using a line inversion mode or a field inversion mode in accordance with an embodiment of the invention.

FIG. 10 shows various voltage levels in a field-sequential display (FSLCD) for a quick white-black transition using a dot or column inversion mode in accordance with an embodiment of the invention.

FIG. 11 shows a primary-color frame comparison among a conventional TFT LCD display with color filters, a synchronous-type field sequential display with primary color LED's in accordance with an embodiment of the invention, and an advanced synchronous-type field sequential display with primary color LED's in accordance with another embodiment of the invention.

FIG. 12 shows an example of a temperature-dependent LED-emitting duration adjustment to keep a relatively consistent display brightness level at various color temperatures in accordance with an embodiment of the invention.

FIG. 13 shows an example of a logic block containing boosted VCOM and Gamma (i.e. gray scale) reference voltage control and generators for a quarter-VGA (QVGA) application, in accordance with an embodiment of the invention.

FIG. 14 contains Tables 1˜4. Table 1 shows an example of transition times for a 6-bit color LCD without any response time compensation. Table 2 shows an example of a lookup table (LUT) for data response time compensation in accordance with an embodiment of the invention. Table 3 shows an example of transition times for a 6-bit color LCD with data response time compensation in accordance with an embodiment of the invention. Table 4 shows an example of transition times for a 6-bit color LCD with data response time compensation and boosted VCOM/Gamma voltages in accordance with an embodiment of the invention.

FIG. 15 contains Table 5˜7. Table 5 shows an example of a lookup table (LUT) for LED lamp-emitting durations relative to various color temperatures in accordance with an embodiment of the invention. Table 6 shows some feature comparisons between a conventional color TFT LCD with color filters versus a field-sequential LCD (FSLCD) in accordance with an embodiment of the invention. Table 7 shows an input/output comparison between a conventional driver IC for a color TFT LCD with color filter s versus a field-sequential LCD (FSLCD) driver IC in accordance with an embodiment of the invention.

FIG. 16 shows a method for reducing erroneous color effects in a field sequential liquid crystal display (FSLCD) in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of figures, procedures, logic blocks, processing, and/or other symbolic representations that directly or indirectly resemble a method and an apparatus for improvements to a driver IC for field-sequential liquid crystal display. These descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order and do not imply any limitations in the invention.

In general, embodiments of the invention relate to driver IC's for field-sequential liquid crystal displays (FSLCD's). More specifically, an embodiment of the invention relates to a method and an apparatus to provide response time compensation (RTC) function at data signal, finer subdivision of sub-frames within each frame, and boosted Gamma reference voltage and/or VCOM voltages to a FSLCD panel to enable commonly-used liquid crystal technologies such as twisted nematic (TN), in-plane switching (IPS), vertical align (VA), and other variants to satisfy a rigorous pixel cell response time requirement of the FSLCD panel.

Furthermore, an embodiment of the invention relates to a method and an apparatus for subdividing a frame into a multiple number of sub-frames, wherein some sub-frames are grouped together for preparing for a liquid crystal pixel cell light transmittance response and primary-color (i.e. red, green, or blue) LED on-screen time. For example, a frame can be subdivided into nine equally-spaced sub-frames, wherein three sets of three sub-frames for the nine equally-spaced sub-frames are grouped together to make each set represent “boost,” “normal,” and “idle” sub-frames for a liquid crystal pixel response preparation and an on-screen duration of a primary-color LED (i.e. red, green, or blue).

In addition, an embodiment of the invention relates to achieving a relatively consistent brightness to a human eye regardless of varying color temperatures of primary-color backlight LED's by using a lookup table to adjust a light-emitting duration of a particular primary-color LED depending on a current color temperature.

Furthermore, one objective of the invention is to provide a method and an apparatus for enabling commonly-used liquid crystal technologies such as twisted nematic (TN), in-plane switching (IPS), vertical align (VA), and other variants to satisfy a rigorous pixel cell response time requirement of a FSLCD panel.

A further objective of the invention is to provide a method and an apparatus for subdividing a frame into a multiple number of sub-frames, wherein some sub-frames are grouped together for preparing for a liquid crystal pixel cell light transmittance response and primary-color (i.e. red, green, or blue) LED on-screen time. For example, a frame can be subdivided into nine equally-spaced sub-frames, wherein three sets of three sub-frames for the nine equally-spaced sub-frames are grouped together to make each set represent “boost,” “normal,” and “idle” sub-frames for a liquid crystal pixel response preparation and an on-screen duration of a primary-color LED (i.e. red, green, or blue).

Yet another objective of the invention is to achieve a relatively consistent display brightness to a human eye regardless of varying color temperatures of primary-color backlight LED's by using a lookup table to adjust a light-emitting duration of a particular primary-color LED depending on a current color temperature.

For the purpose of describing the invention, a term “frame” is defined as a time interval used for preparation of a liquid crystal pixel to a desired light transmittance level for a sequence of at least three primary-color backlighting LED's (i.e. red, green, and blue), wherein the sequence occupies time slots for potential transmission of at least three primary-color LED's in one frame.

Furthermore, for the purpose of describing the invention, a term “sub-frame” is defined as a subdivided time interval within a frame, wherein each sub-frame may be related to a particular backlighting LED color (e.g. red, green, or blue) and categorized as a color-specific-“boost” sub-frame, a color-specific “normal” sub-frame, or a color-specific “idle” sub-frame.

Moreover, for the purpose of the describing the invention, a term “color frame” is defined as a window of time in which an LED backlight of a particular color may be operational, wherein the color frame may be further subdivided into sub color frames, or fractions of the window of time in which the LED backlight of the particular color may be operational. For example, a red color frame, a green color frame, and a blue color frame can occupy one frame, wherein the red color frame is further subdivided into two sub color frames or three sub color frames. A sub color frame of a particular primary color can be a sub-frame which periodically occurs three times per frame, if the frame contains 9 sub-frames and primary-color frames repeat in the order of “a red frame-a green frame-a blue frame” three times per frame.

In addition, for the purpose of describing the invention, a term “gray scale” is used to describe one or more functional blocks associated with monochromatic (i.e. varying intensities of gray, ranging from white to complete black) image control. On the other hand, a term “gray level” is used to refer to an amount of gray scale intensity.

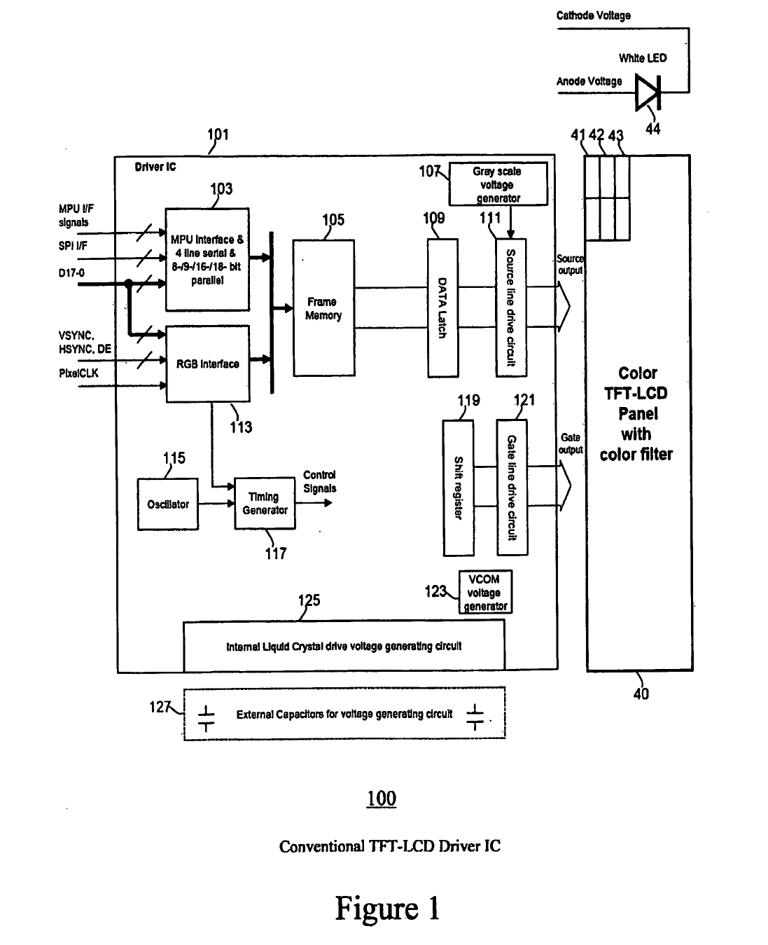

FIG. 1 shows a conventional driver IC (101) for a typical color TFT LCD panel (40) with primary color filters (e.g. 41, 42, 43). In this particular example (100) as shown in FIG. 1, the conventional driver IC (101) comprises a microprocessor interface & 4 line serial & 8, 9, 16, and 18-bit parallel unit (103), a primary-color “red, green, blue,” or RGB interface (113), a frame memory (105), a data latch (109), a source line drive circuit (111), a gray scale voltage generator (107), an oscillator (115), a timing generator (117), a shift register (119), a gate line driver circuit (121), a VCOM voltage generator (123), and an internal liquid crystal drive voltage generating circuit (125). The conventional driver IC (101) is configured to provide necessary electrical voltages to columns and rows of a color TFT LCD panel (40) with color filters (e.g. 41, 42, 43) and control analog display signals transmitted to the color TFT LCD panel (40).

The microprocessor interface & 4 line serial & 8, 9, 16, and 18-bit parallel unit (103) and the primary-color “red, green, blue,” or RGB interface (113) receives display-related data and control signals (e.g. MPU I/F signals, SPI I/F signals, D17-0, VSYNC, HSYNC, data enable (DE), pixel CLK, and etc.) and control and synthesize display data signals. The display data signals are then typically stored in the frame memory (105), wherein a size of the display data is related to a display resolution of the color TFT LCD panel (40). For example, a 240×320 display with 6-bit color depth requires 1,382,400 bits (i.e. 240×320×18=1,382,400). The stored display data signals in the frame memory (105) are then transmitted to the data latch (109) and the source line drive circuit (111) which combines relevant voltage information from the gray scale voltage generator (107) to provide electrical voltages and analog data source signals to columns of the color TFT LCD panel (40) with color filters (e.g. 41, 42, 43). The gray scale voltage generator (107) is configured to generate electrical voltages to drive liquid crystals in the color TFT LCD panel (40) according to one or more gray level setting values in a gamma correction register.

Continuing with FIG. 1, the oscillator (115) generates one or more internal clock and frame frequencies which can be adjusted by a control command. The timing generator (117) outputs at least some control signals to a plurality of functional blocks in the driver IC (101). The internal liquid crystal driver voltage generating circuit (125) is configured to generate a VDD (gray scale voltage), a VGH (gate high voltage), and a VGL (gate low voltage). External capacitors for voltage generating circuit (127) are generally placed outside of the conventional driver IC (101). The shift register (119) and the gate line drive circuit (121) are configured to provide gate output signals to the color TFT LCD panel (40). The gate output signals control capacitor voltages of liquid crystal pixels, wherein the capacitor voltages of the liquid crystal pixels correlate to light transmittance levels of each pixel. The gate output signals are typically transmitted to rows of a TFT matrix in the color TFT LCD panel (40), whereas the analog data source signals and relevant electrical voltages are sent to columns of the TFT matrix in the color TFT LCD panel (40). The typical color TFT LCD panel (40) with color filters (e.g. 41, 42, 43) as shown in FIG. 1 also has a white LED or a white fluorescent backlighting to the TFT matrix to provide sufficient backlighting to the color TFT LCD panel (40).

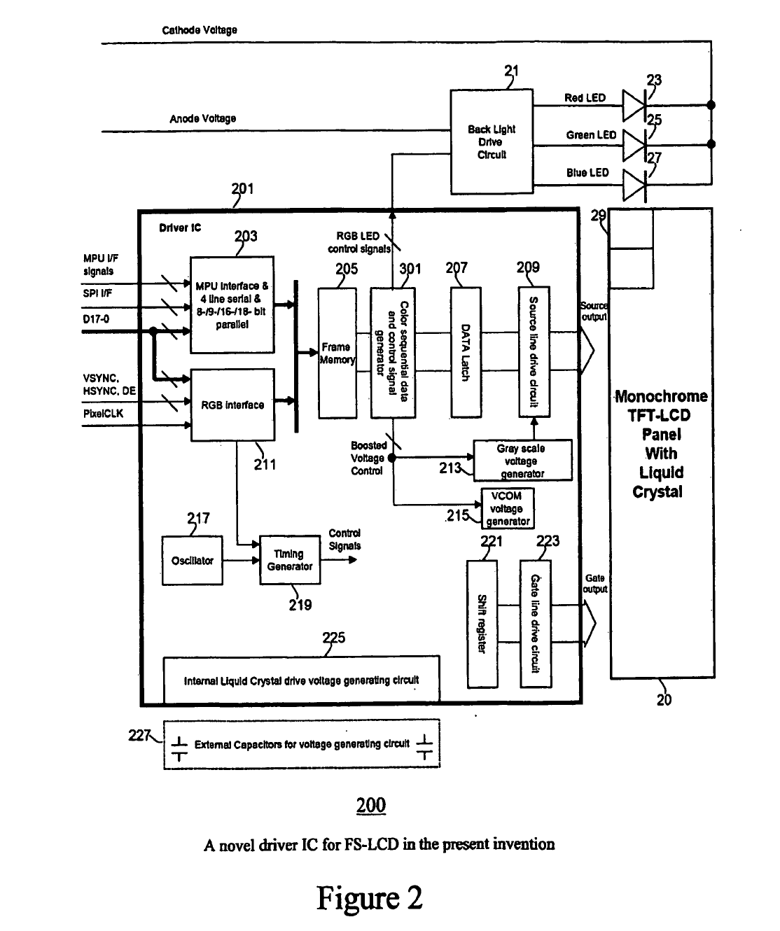

FIG. 2 shows a novel driver IC (201) for a field-sequential LCD (FSLCD) in accordance with an embodiment (200) of the invention. One key difference between the conventional driver IC (101) for the typical color TFT LCD panel (40) and the novel driver IC (201) for the FSLCD is that the novel driver IC (201) for the FSLCD controls and provides analog display data signals to a monochrome TFT LCD panel (20) instead of using the color TFT LCD panel (40) with color filters (e.g. 41, 42, 43). The monochrome TFT LCD panel (20) does not need to incorporate any color filters for an FSLCD implementation. In order to provide coloring effects to the FSLCD, the novel driver IC (201) as shown in FIG. 2 coordinates and controls primary color (i.e. “RGB”) control signals to a back light drive circuit (21). In one embodiment of the invention, the back light drive circuit (21) provides electrical voltage and power necessary to turn individual primary-color LED backlights (e.g. 23, 25, 27) on or off.

It is important to note that in a FSLCD, the backlighting itself provides coloring effects to the display panel, instead of simply lighting up the display panel with a white backlighting, which is typical in a conventional color TFT LCD. The primary-color sequential backlighting without color filters in liquid crystal pixels can provide coloring effects to the display panel because the FSLCD achieves coloring effects by visual illusion to a human eye using rapidly-refreshable color backlighting to a monochrome display panel, as shown by one embodiment (200) of the present invention using the monochrome TFT LCD panel (20). For example, a rapid sequential primary-color (i.e. RGB) backlighting of the monochrome TFT LCD panel (20) creates an effect of true colors in a human eye, which cannot distinguish individual primary colors if they are presented sequentially at a rate faster than an average minimum threshold value for color distinction achieved by the human eye. For instance, a red LED backlight lighting up for a first particular pixel in the FSLCD for a multiple number of consecutive frames, while the other two primary color LED's (i.e. green and blue) remain off, creates an effect of continuous red color for the first particular pixel to the human eye. On the other hand, a red LED backlight and a green LED backlight sequentially and consecutively lighting up for a second particular pixel in the FSLCD for a multiple number of consecutive frames, while a blue LED remains off, creates an effect of continuous yellow color for the second particular pixel to the human eye.

There are several advantages to an FSLCD compared to a conventional color TFT LCD with color filters. One major advantage is that the FSLCD in theory exhibits three times higher light transmissivity than the conventional color TFT LCD, because a pixel in the conventional color TFT LCD is divided into at least three sub-pixels to support color filtering. Because an area of light transmission in a sub-pixel of the conventional color TFT LCD is one-third (i.e. ⅓) the size of a monochrome liquid crystal pixel used for the FSLCD, the conventional color TFT LCD is significantly less energy efficient and requires more power for backlighting, compared to the FSLCD. Furthermore, because the FSLCD does not require color filters and the color filters are a source of significant manufacturing cost of the conventional color TFT LCD, the FSLCD is cost-effective to manufacture. Moreover, the conventional color TFT LCD with at least three sub-pixels crammed in each pixel has been a major obstacle in achieving ultra-high resolutions in small display devices. The FSLCD's monochrome pixel structure without sub-pixels is much more advantageous in achieving ultra-high resolutions in small display devices.

However, the FSLCD's currently prototyped or produced in small volumes in the market today have not resolved slow liquid crystal pixel response times for commonly-used liquid crystal technologies such as twisted nematic (TN), in-plane switching (IPS), vertical align (VA), and other variants. The slow liquid crystal pixel response times exhibited by cheaper and commonly-used liquid crystal technologies have not been able to accommodate rapid sub-frame rate requirement for primary-color backlighting sequences in an FSLCD design, which has hampered a widespread and a cost-effective commercial use of the FSLCD's in the recent years. Most implementations of the FSLCD's in the market today require the use of an expensive OCB-type liquid crystal materials which have very fast liquid crystal pixie response times.

The present invention significantly resolves slow liquid crystal pixel response issues in commonly-used liquid crystal materials by using a unique response time compensation (RTC) scheme, boosted Gamma reference voltage and/or VCOM voltages, and finer subdivision of sub-frames within each frame. Continuing with FIG. 2, most of these techniques enabling the commonly-used liquid crystal materials to be used for FSLCD applications are controlled and embodied by a color sequential data and control signal generator (301) of FIG. 2, wherein the color sequential data and control signal generator (301) integrates a response time compensation block for boosted voltage control, an LED control block to coordinate and control primary-color LED activation sequences, and a lookup table block for LED-emitting duration adjustment based on color temperatures for a relatively consistent brightness of the display.

In one embodiment of the present invention (200) as shown in FIG. 2, the novel driver IC (201) comprises a microprocessor interface & 4 line serial & 8, 9, 16, and 18-bit parallel unit (203), a primary-color “red, green, blue,” or RGB interface (211), a frame memory (205), the color sequential data and control signal generator (301), a data latch (207), a source line drive circuit (209), a gray scale voltage generator (213), an oscillator (217), a timing generator (219), a shift register (221), a gate line driver circuit (223), a VCOM voltage generator (215), and an internal liquid crystal drive voltage generating circuit (225).

The novel driver IC (201) for the FSLCD is configured to provide necessary electrical voltages to columns and rows of a monochrome TFT LCD panel (20), coordinate and control the back light driver circuit (21) for primary-color LED backlighting, and control analog display signals transmitted to the monochrome TFT LCD panel (20) with a plurality of monochrome liquid crystal pixels (e.g. 29).

In one embodiment (200) of the present invention, some functional blocks other than the color sequential data and control signal generator (301), the backlight driver circuit (21), the primary-color LED's (e.g. 23, 25, 27), and the monochrome TFT LCD panel without color filters, are at least somewhat functionally similar to the corresponding functional blocks of the conventional driver IC (101). For instance, the microprocessor interface & 4 line serial & 8, 9, 16, and 18-bit parallel unit (203) and the primary-color “red, green, blue,” or RGB interface (211) receive display-related data and control signals (e.g. MPU I/F signals, SPI I/F signals, D17-0, VSYNC, HSYNC, data enable (DE), pixel CLK, and etc.) and control and synthesize display data signals. The display data signals are then typically stored in the frame memory (205), wherein a size of the display data is related to a display resolution of the monochrome TFT LCD panel (20). The stored display data signals in the frame memory (205) are then transmitted to the color sequential data and control signal generator (301), which integrates a response time compensation block for boosted voltage control, an LED control block to coordinate and control primary-color LED (e.g. 23, 25, 27) activation sequences for the back light drive circuit (21), and a lookup table for color temperature adjustment for relatively consistent brightness of the display.

The color sequential data and control signal generator (301) is configured to manipulate display data signals by using a response time compensation (RTC) scheme and/or a VCOM/Gamma reference voltage boosts to minimize erroneous color effects caused by insufficiently slow light transmittance transition time for one or more liquid crystal pixel cells. The manipulated display data from the color sequential data and control signal generator (301) are then transmitted to the data latch (207) and the source line drive circuit (209) which combines relevant voltage information from the gray scale voltage generator (213) to provide electrical voltages and analog data source signals to columns of the monochrome TFT LCD panel (20). The gray scale voltage generator (213) is configured to generate electrical voltages to drive liquid crystals in the monochrome TFT LCD panel (20) according to one or more gray level setting values in a gamma correction register. In one preferred embodiment of the invention, the gray scale voltage generator (213) can output same voltage during all sub-frames, or a higher voltage for a black-color and a lower voltage for a white-color during a first sub-frame for black-to-white or white-to-black transitions in an RTC scheme. Furthermore, the gray scale voltage generator (213) can generate different voltages for a second sub-frame and a third sub-frame for making different gray curve per primary color (i.e. red, green and blue). The VCOM voltage generator (215) can generate and transmit a differentiated boosted voltage at a first sub-frame for RTC scheme of black-to-white or white-to-black transition.

In one embodiment of the invention, the sequential data and control signal generator (301) supports a response time compensation scheme with an internal data RTC block operatively connected to an RTC lookup table. In a preferred embodiment of an RTC implementation, the data RTC block refers to the RTC lookup table to provide a fast transition response time from one gray level to another gray level using a response time compensation (RTC) scheme during a primary-color (i.e. red, green, and blue) LED-backlighting sequence. The RTC lookup table can retrieve an RTC gray level command value based on a previous gray level command value to a pixel vs. a current gray level command value to the same pixel. The RTC gray level command value may be an “under-boost” command or an “over-boost” command to the pixel, depending on empirical values gathered to compose the RTC lookup table for a particular display panel and any relevant components. The RTC scheme enables a fast transition response time from one gray level to another gray level by either under-boosting or over-boosting the pixel with an RTC gray level command value retrieved from the RTC lookup table. Furthermore, the sequential data and control signal generator (301) supports a boosted VCOM voltage control signal which can be transmitted to the VCOM voltage generator (215). In addition, the sequential data and control signal generator (301) can also support a Gamma reference voltage control signal sent to the Gray scale voltage generator (213) for fast gray level transition to remove residual color caused by a slow transition time between liquid crystal light transmittance levels (e.g. a gray-level to black, a gray-level to white, and etc.).

Continuing with FIG. 2, the oscillator (217) generates one or more internal clock and frame frequencies which can be adjusted by a control command. In a preferred embodiment of the invention, the oscillator (217) for the FSLCD has 9 times higher frequency than the oscillator (115) for the conventional color TFT LCD in order to accommodate 9 sub-frames per frame in the FSLCD to make liquid crystal pixels with slow response time compatible with rapid primary-color LED backlighting sequences. In another embodiment of the invention, the oscillator (217) for the FSLCD has 4.5 times higher frequency than the oscillator (115) for the conventional color TFT LCD if a double data rate (DDR) memory is used for the frame memory (205).

The timing generator (219) outputs at least some control signals to a plurality of functional blocks in the novel driver IC (201). In a preferred embodiment of the invention, the timing of the control signals from the timing generator (219) matches the frequency generated by the oscillator (217), which may be 9 times or 4.5 times faster (i.e. depending on the number of sub-frames per frame in the FSLCD) than the timing of the control signals for the conventional color TFT LCD. In an FSLCD application, the control signals are typically generated in every sub-frame (e.g. approx. 1.85 ms if 9 sub-frames are used for a frame duration of 16.67 ms), instead of being generated in every frame (e.g. 16.67 ms) as in the case of the conventional color TFT LCD. The internal liquid crystal driver voltage generating circuit (225) is configured to generate a VDD (gray scale voltage), a VGH (gate high voltage), and a VGL (gate low voltage). External capacitors for voltage generating circuit (227) are generally placed outside of the novel driver IC (201). The shift register (221) and the gate line drive circuit (223) are configured to provide gate output signals to the monochrome TFT LCD panel (20). The gate output signals control capacitor voltages of liquid crystal pixels, wherein the capacitor voltages of the liquid crystal pixels correlate to light transmittance levels of each pixel. The gate output signals are typically transmitted to rows of a TFT matrix in the monochrome TFT LCD panel (20), whereas the analog data source signals and relevant electrical voltages are sent to columns of the TFT matrix in the monochrome TFT LCD panel (20).

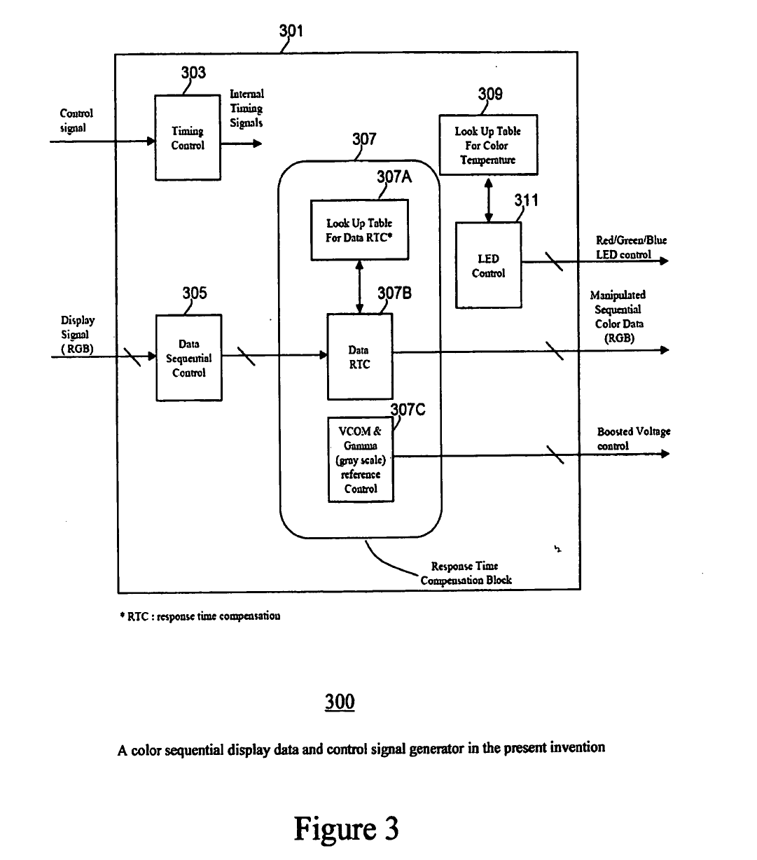

FIG. 3 shows a color sequential display data and control signal generator block (301) in accordance with an embodiment of the invention. In one preferred embodiment of the invention, the color sequential data and control signal generator (301) integrates a response time compensation block (307) for boosted voltage control, an LED control block (311) to coordinate and control primary-color LED activation sequences, a lookup table block (309) for LED-emitting duration adjustment based on an ambient temperature (i.e. also called “color temperature”) near LED backlights for a relatively consistent brightness of the display, a timing control block (303), and a data sequential control block (305). In one embodiment of the invention, a color temperature is measured by a thermometer inside or near an LED backlight assembly for an FSLCD unit, and the color temperature reading can be fed back into the color sequential data and control signal generator (301) for a dynamic adjustment of an LED-emitting duration for a particular primary-color LED backlight based on color temperature data stored in the lookup table block (309).

In one preferred embodiment of the invention, the timing control block (303) receives one or more control signals and generate necessary timing control signals for internal use. The data sequential control block (305) receives display signal data and generates sequential color display data categorized by each frame and/or sub-frames of each frame. In one embodiment of the invention, the response time compensation block (307) comprises a lookup table (307A) for data RTC, a data RTC block (307B), and a VCOM & Gamma (i.e. gray scale) reference control block (307C). The data RTC block (307B) refers to the lookup table (307A) to provide a fast transition response time from one gray level to another gray level using a response time compensation (RTC) scheme during a primary-color (i.e. red, green, and blue) LED-backlighting sequence. In one embodiment of the invention, the lookup table (307A) retrieves an RTC gray level command value based on a previous gray level command value to a pixel vs. a current gray level command value to the same pixel. The RTC gray level command value may be an “under-boost” command or an “over-boost” command, depending on empirical values gathered to compose the lookup table (307A) for a particular display panel and any relevant components. The RTC scheme enables a fast transition response time from one gray level to another gray level by either under-boosting or over-boosting the pixel with an RTC gray level command value retrieved from the lookup table (307A). Furthermore, a boosted VCOM voltage control signal or a Gamma reference voltage control signal is generated from the VCOM & Gamma (gray scale) reference control block (307C) for fast gray level transition to remove residual color caused by a slow transition time between liquid crystal light transmittance levels (e.g. a gray-level to black, a gray-level to white, and etc.).

Continuing with FIG. 3, the lookup table (307A) for data RTC can be placed outside of the color sequential display data and control signal generator block or even outside the driver IC (e.g. 201) as long as the lookup table (307A) is operatively connected to the data RTC block (307B). In one embodiment of the invention, the lookup table (307A) and control values for the VCOM & Gamma (gray scale) reference control block (307C) can be adjusted from an external Serial Peripheral Interface (SPI) bus or an I2C bus. The LED control block (311) is configured to control primary-color LED backlights (i.e. red, green, and blue) for an FSLCD in accordance with an embodiment of the invention. Optionally, the LED control block (311) may refer to the lookup table block (309) for LED-emitting duration adjustment for a relatively consistent brightness of the display regardless of LED backlight temperature (i.e. commonly called “color temperature”).

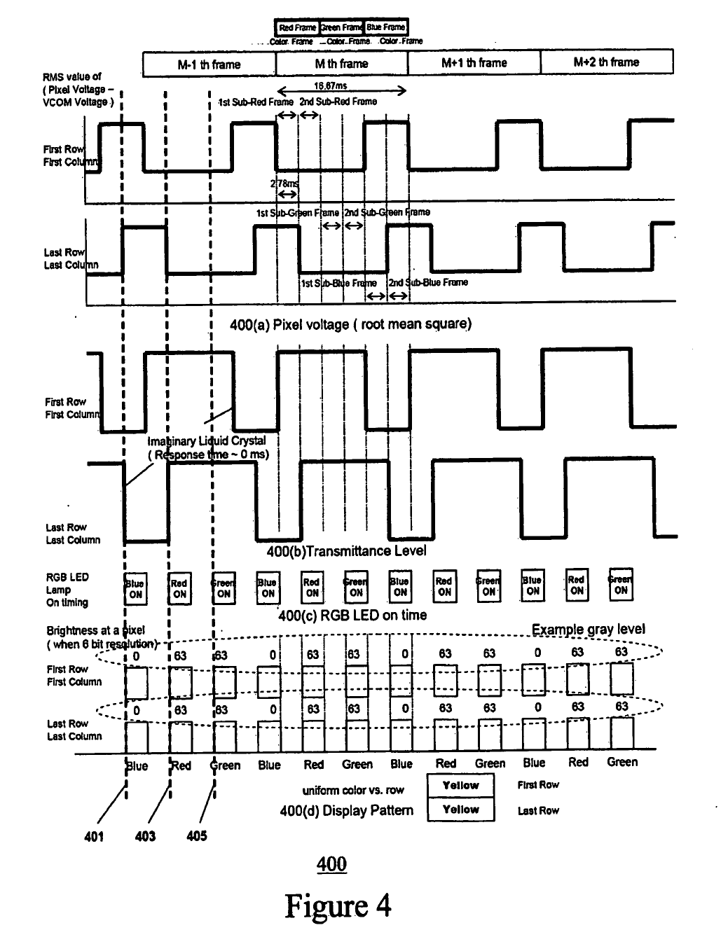

FIG. 4 shows an example (400) of relationships among pixel voltages (400(a)) pixel light transmittance levels (400(b)), primary-color LED emitting timings (400(c)), and resulting display patterns (400(d)) relative to time for a field-sequential LCD (FSLCD) in a theoretical ideal case. In this theoretical ideal case, each frame (e.g. M−1th frame, Mth frame, M+1th frame, and etc.) has three color frames (i.e. red, green, and blue color frames), which are further subdivided into two sub color frames per color, for a total of 6 sub-frames (i.e. which can also be called 6 sub color frames) per frame. Two waveforms for the pixel voltages over time (400(a)) show root-mean-square values of the pixel voltages and VCOM voltages for a first row-first column pixel and a last row-last column pixel. Furthermore, two additional waveforms for light transmittance levels (400(b)) over time show light transmittance ratios of imaginary ideal liquid crystal pixels at the first row-first column and the last row-last column, each pixel having 0-ms transition time (i.e. a time consumed for a pixel's brightness transition from a gray level to another gray level, which is also described with a phrase “response time” interchangeably in the specifications) due to an induced electric field at each pixel according to root-mean-square value pixel voltage.

The primary-color LED emitting timings (400(c)) in FIG. 4 indicate LED lamp “on” timing for red, blue, or green LED as backlights in a FSLCD. In one embodiment of the invention, in order to remove color residual from the first row-first column pixel to the last row-last column pixel, LED “on” time is required to be almost 2.78 ms, or ⅙^{th} of a typical duration for one frame, which is 16.67 ms. Assuming that display conditions were according to pixel voltages (400(a)), pixel light transmittance levels (400(b)), and primary-color LED emitting timings (400(c)) over a commonly-shared time period, the resulting display patterns (400(d)) relative to time for the FSLCD in the theoretical ideal case correctly displays a desired color “yellow” for the first row-first column pixel and the last row-last column pixel to the human eye by keeping the red and the green LED lamps at a high light transmittance with the same gray levels (e.g. 63) in consecutive sequences while keeping the blue LED lamp effectively blocked out by completely blocking light transmittance through the relevant pixels by adjusting the gray level to zero during the blue LED lamp timing. In the example of FIG. 4, the gray level at a pixel in the resulting display patterns (400(d)) is indicated by a numerical value ranging from 0 to 63 for a 6-bit resolution display, with a gray level 0 indicating zero light transmittance (i.e. a pixel is completely blocking light) and 63 indicating the maximum light transmittance (i.e. a pixel at a maximum light transmissivity).

It should be noted that a FSLCD typically uses a line-scanning method for refreshing display data on a FSLCD panel. Because a pixel on the last row-last column receives display data refresh some time after a pixel on the first row-first column, waveform delays between the first row-first column and the last row-last column in pixel voltages (400(a)) and pixel light transmittance levels (400(b)) are considered a typical operating condition, even in the theoretically ideal case in which liquid crystal pixels are assumed to have no transmittance level-related transition delays.

Continuing with FIG. 4, a first time slice (401) in the theoretically ideal case has both the first row-first column pixel and the last row-last column pixel at zero light transmittance level when a blue LED lamp is “on”. Therefore, no blue light is transmitted through the liquid crystal pixels. A second time slice (403) in the theoretically ideal case has both the first row-first column pixel and the last row-last column pixel at maximum light transmittance level (i.e. 63) when a red LED lamp is “on”. Likewise, a third time slice (405) in the theoretically ideal case has both the first row-first column pixel and the last row-last column pixel at maximum light transmittance level (i.e. 63) when a green LED lamp is “on”. A resulting display pattern to a human eye is a mixed color of yellow because a red color and a green color are sequentially displayed with equal brightness for several frames, while a blue color was entirely blocked. In reality, because there are transition time or response time delays associated with liquid crystal pixels for changing light transmittance levels, the theoretically ideal case is far from a realistic representation of behavior of liquid crystal pixels which exhibit significant transition delays, which will result in erroneous coloring effects in the FSLCD.

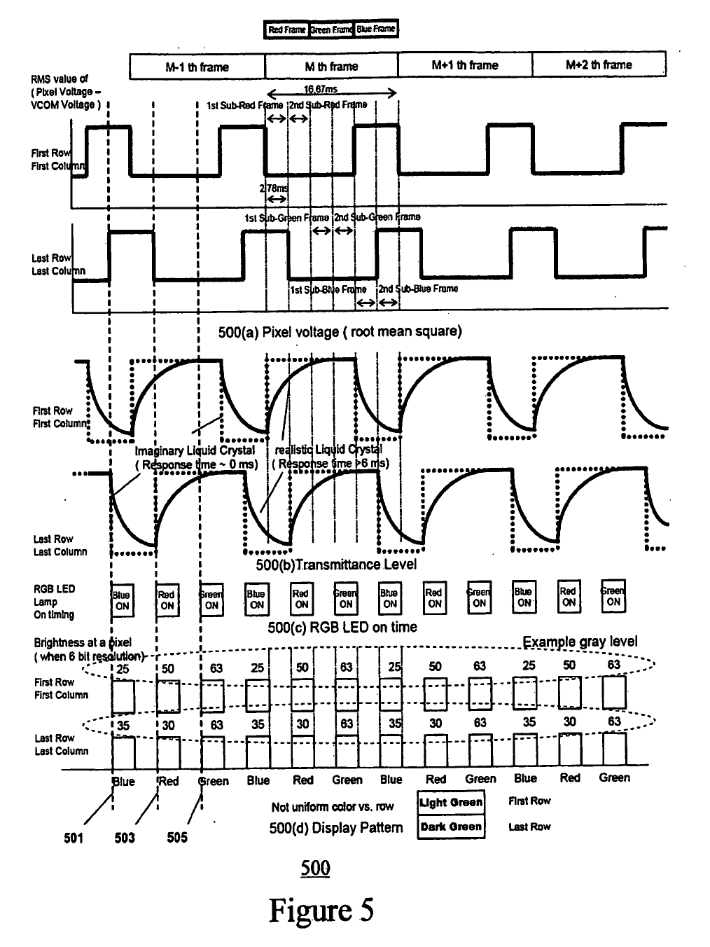

FIG. 5 shows an example (500) of relationships among pixel voltages (500(a)), pixel light transmittance levels (500(b)), primary color LED emitting timings (500(c)), and resulting display patterns (500(d)) relative to time for a field-sequential LCD (FSLCD) in a realistic case without any response time compensation. In this realistic case without any response time compensation, each frame (e.g. M−1th frame, Mth frame, M+1th frame, and etc.) has three color frames (i.e. red, green, and blue color frames), which are further subdivided into two sub color frames per color, for a total of 6 sub-frames (i.e. which can also be called 6 sub color frames) per frame. Two waveforms for the pixel voltages over time (500(a)) show root-mean-square values of the pixel voltages and VCOM voltages for a first row-first column pixel and a last row-last column pixel. It should be noted that a FSLCD typically uses a line-scanning method for refreshing display data on a FSLCD panel. Because a pixel on the last row-last column receives display data refresh some time after a pixel on the first row-first column, waveform delays between the first row-first column and the last row-last column in pixel voltages (500(a)) and pixel light transmittance levels (500(b)) are considered a typical operating condition.

Furthermore, two additional waveforms for light transmittance levels (500(b)) over time show light transmittance ratios of realistic and commonly-used liquid crystal pixels (i.e. other than an exotic and expensive LCD technology such as OCB) at the first row-first column and the last row-last column, each pixel taking a significant transition time (i.e. a time consumed for a pixel's brightness transition from a gray level to another gray level, which is also described with a phrase “response time” interchangeably in the specifications) due to an induced electric field at each pixel according to root-mean-square value pixel voltage. The significant transition time is illustrated by downward and upward curves of light transmittance levels relative to time for a realistic and commonly-used liquid crystal pixel cell.

The primary-color LED emitting timings (500(c)) in FIG. 5 indicate LED lamp “on” timing for red, blue, or green LED as backlights in a FSLCD. In one embodiment of the invention, in order to remove color residual from the first row-first column pixel to the last row-last column pixel, LED “on” time is required to be almost 2.78 ms, or ⅙^{th} of a typical duration for one frame, which is 16.67 ms. Assuming that display conditions were according to pixel voltages (500(a)), realistic pixel light transmittance levels (500(b)) without any response time compensation (RTC) schemes, and primary-color LED emitting timings (500(c)) over a commonly-shared time period, the resulting display patterns (500(d)) relative to time for the FSLCD in the realistic case without any RTC schemes erroneously display a light greenish color for the first row-first column pixel and a darker greenish color for the last row-last column pixel to the human eye, when a desired color effect was a plain yellow color.

The erroneous light greenish color for the first row-first column pixel and the darker greenish color for the last row-last column pixel to the human eye, as shown by the resulting display patterns (500(d)) in the example (500) of FIG. 5 are attributed to residual gray levels for a commonly-used liquid crystal pixel during a transition of light transmittance levels (i.e. gray level transitions). More specifically, the light transmittance levels (i.e. gray levels) for the first row-first column pixel and the last row-last column pixel at the time of blue LED lamp is “on” are not at zero, thereby “leaking” some blue LED light to the pixels, as illustrated by gray level values 25 and 35 at a first time slice (501). The leaking blue LED backlight is attributed to an insufficient transition speed of light transmittance levels for the relevant pixels in the FSLCD. Furthermore, the light transmittance levels for the first row-first column pixel and the last row-last column pixel at the time of red LED lamp is “on” may also not be consistent, as illustrated by gray level values 50 and 30 at a second time slice (503). Although the example (500) in FIG. 5 shows that the gray level values are consistent (i.e. 63's) for the first row-first column pixel and the last row-last column pixel at a third time slice (505) when the green LED lamp is “on”, the blue LED leakage when the blue LED is “on” and inconsistent gray levels when the red LED is “on” results in grossly-erroneous color effects to the human eye: the light greenish color for the first row-first column pixel and the darker greenish color for the last row-last column pixel, even though a desired color effect was plain yellow.

These undesirable delays during light transmittance level transitions of pixels, as shown by the example (500) in FIG. 5, result in erroneous color effects in an FSLCD and have been a major hurdle in cost-effective commercialization of FSLCD's, because most cost-effective liquid crystal technologies and materials do not have sufficiently fast light transmittance level transition times (i.e. also interchangeably called “response time” in this specification) to overcome much of these erroneous color effects.

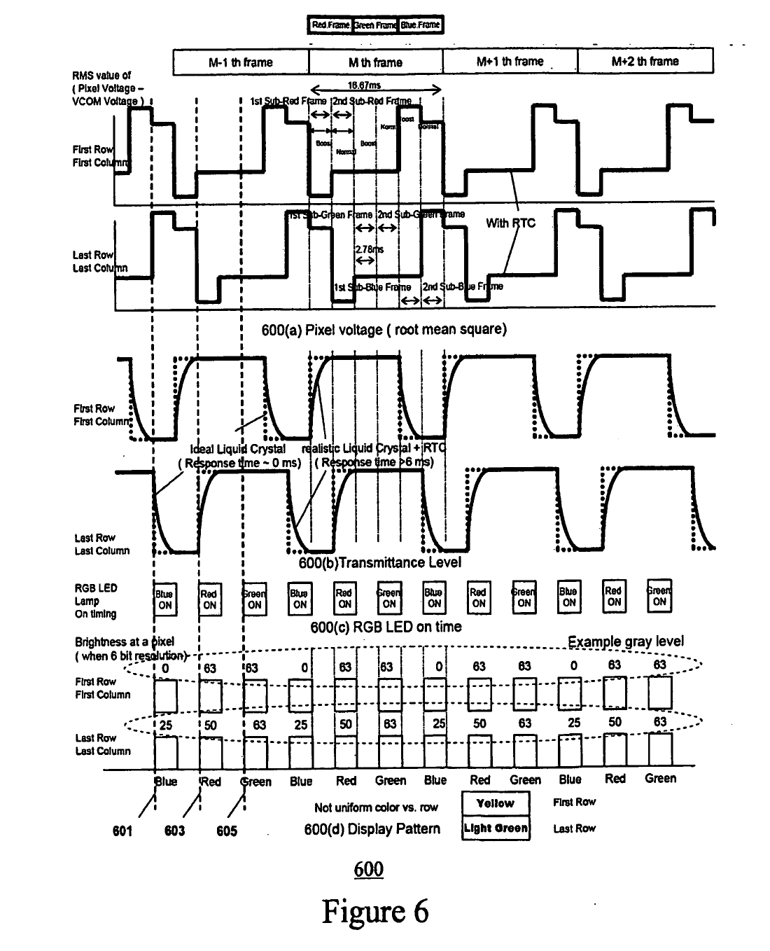

FIG. 6 shows an example (600) of relationships among pixel voltages (600(a)), pixel light transmittance levels (600(b)), primary color LED emitting timings (600(c)), and resulting display patterns (600(d)) relative to time for a field-sequential LCD (FSLCD) with a simple response time compensation (RTC) scheme in accordance with an embodiment of the invention. In this realistic case with a simple response time compensation (RTC) scheme, each frame (e.g. M−1th frame, Mth frame, M+1th frame, and etc.) has three color frames (i.e. red, green, and blue color frames), which are further subdivided into two sub color frames per color, for a total of 6 sub-frames (i.e. which can also be called 6 sub color frames) per frame. Two waveforms for the pixel voltages over time (600(a)) show root-mean-square values of the pixel voltages and VCOM voltages for a first row-first column pixel and a last row-last column pixel. Of particular importance is an under-boost voltage value or an over-boost voltage value for pixel voltages in the two waveforms for the pixel voltage over time (600(a)), which is based on a general RTC concept designed to reduce a pixel gray level transition time.

It should be noted that a FSLCD typically uses a line-scanning method for refreshing display data on a FSLCD panel. Because a pixel on the last row-last column receives display data refresh some time after a pixel on the first row-first column, waveform delays between the first row-first column and the last row-last column in pixel voltages (600(a)) and pixel light transmittance levels (600(b)) are considered a typical operating condition.

Furthermore, two additional waveforms for light transmittance levels (600(b)) over time shows light transmittance ratios of realistic and commonly-used liquid crystal pixels (i.e. other than an exotic and expensive LCD technology such as OCB-type LCD's) at the first row-first column and the last row-last column, each pixel taking a substantially reduced transition time (i.e. a time consumed for a pixel's brightness transition from a gray level to another gray level, which is also described with a phrase “response time” interchangeably in the specifications) by using a simple RTC scheme. An RTC scheme generally involves over-boosting or under-boosting a pixel voltage by replacing a raw gray level command value of current display data with an RTC gray level command value retrieved from an RTC lookup table. In general, the RTC look up table requires a previous gray level command value and a current, raw gray level command value to retrieve the RTC gray level command value. The RTC gray level command value is typically entered in the RTC lookup table based on empirical experimentations of speeding up the light transmittance (i.e. gray level) transition time of a liquid crystal pixel cell by under-boosting or over-boosting the pixel voltage. The substantially reduced transition time by using the simple RTC scheme is illustrated by steeper downward and upward curves of light transmittance levels relative to time for a realistic and commonly-used liquid crystal pixel cell.

Continuing with FIG. 6, the primary-color LED emitting timings (600(c)) in FIG. 6 indicate LED lamp “on” timing for red, blue, or green LED as backlights in a FSLCD. In one embodiment of the invention, in order to remove color residual from the first row-first column pixel to the last row-last column pixel, LED “on” time is required to be almost 2.78 ms, or ⅙^{th} of a typical duration for one frame, which is 16.67 ms. Assuming that display conditions were according to pixel voltages (600(a)), realistic pixel light transmittance levels (600(b)) with a simple response time compensation (RTC) scheme, and primary-color LED emitting timings (600(c)) over a commonly-shared time period, the resulting display patterns (600(d)) relative to time for the FSLCD are an improvement to the previous example (500) of FIG. 5 which did not have any RTC scheme. Nevertheless, the resulting display patterns (600(d)) with a simple RTC scheme may still exhibit erroneous color effects, as shown by a correct plain yellow color for the first row-first column pixel but an incorrect, light greenish color for the last row-last column pixel to the human eye. The desired color effect in this example (600) was a plain yellow color.

The erroneous light greenish color for the last row-last column pixel to the human eye, as shown by the resulting display patterns (600(d)) in the example (600) of FIG. 6 is still attributed to residual gray levels for a commonly-used liquid crystal pixel during a transition of light transmittance levels (i.e. gray level transitions). Even though the simple RTC scheme increased the transition speed of light transmittance levels for relevant pixels, the transition speed may still not be fast enough to satisfy a rigorous sequential LED backlighting timing requirement of an FSLCD. More specifically, in this example (600), the light transmittance levels (i.e. gray levels) for the first row-first column pixel changed fast enough to block out a blue color when the blue LED lamp is “on” at a first time slice (601). In contrast, the last row-last column pixel when the blue LED lamp is “on” did not have a light transmittance level transition fast enough to reach a gray level value of zero (i.e. instead, reaching the gray level value of 25). Therefore, some blue LED light undesirably “leaks” to the last row-last column pixel during the first time slice (601).

Despite a faster transition of light transmittance levels enabled by the simple RTC scheme in the example (600), the leaking blue LED backlight for the last row-last column pixel case demonstrates that the simple RTC scheme is still not sufficient to always provide desirable, consistent color hues to the FSLCD in at least some rigorous examples. It should be noted that this example (600) as well as previous examples (500, 400) are rigorous examples because they are demonstrating maximum time-delay cases in which a first row-first column pixel is compared against a last row-last column pixel for an FSLCD application that uses a ling-scanning refresh method.

Continuing with FIG. 6, the light transmittance levels for the first row-first column pixel and the last row-last column pixel when the red LED lamp is “on” may also not be consistent, as illustrated by gray level values 63 and 50 at a second time slice (603). Although the example (600) in FIG. 6 shows that the gray level values are consistent (i.e. 63's) for the first row-first column pixel and the last row-last column pixel at a third time slice (605) when the green LED lamp is “on”, the blue LED leakage for the last row-last column pixel and inconsistent gray levels when the red LED is “on” still results in somewhat erroneous color effects to the human eye: a correct, plain yellow color for the first row-first column pixel but an incorrect, light greenish color for the last row-last column pixel.

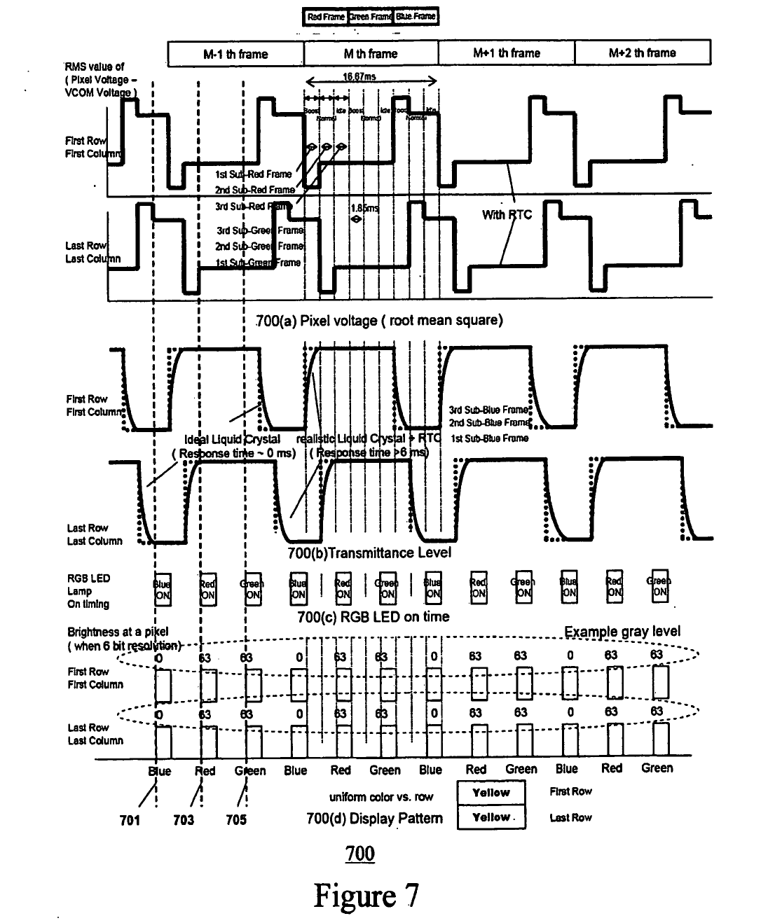

FIG. 7 shows an example (700) of relationships among pixel voltages (700(a)), pixel light transmittance levels (700(b)), primary color LED emitting timings (700(c)), and resulting display patterns (700(d)) relative to time for a field-sequential LCD (FSLCD) with an advanced response time compensation scheme in accordance with a preferred embodiment of the invention. In this realistic example (700) with the advanced response time compensation (RTC) scheme, each frame (e.g. M−1th frame, Mth frame, M+1th frame, and etc.) has three color frames (i.e. red, green, and blue color frames), which are further subdivided into three sub color frames per color, for a total of 9 sub-frames (i.e. which can also be called 9 sub color frames) per frame. The increased number of sub-frames in the advanced RTC scheme account for an additional mode called an “idle” mode on top of conventional “boost” and “normal” modes as shown in FIG. 7, wherein a duration of a frame including the increased number of sub-frames (e.g. 9 sub-frames per frame in FIG. 7 instead of 6 sub-frames in FIGS. 4˜6) is not required to increase from a standard 16.67 ms per frame.

Two waveforms for the pixel voltages over time (700(a)) show root-mean-square values of the pixel voltages and VCOM voltages for a first row-first column pixel and a last row-last column pixel. Of particular importance is an under-boost voltage value or an over-boost voltage value for pixel voltages in the two waveforms for the pixel voltage over time (700(a)), which is based on a general RTC concept designed to reduce a pixel light transmittance level (i.e. gray level) transition time. Unlike a simple RTC scheme, the advanced RTC scheme uses a shorter duration of boost period (e.g. 1.85 ms in FIG. 7 instead of 2.78 ms in FIG. 6) because the advanced RTC scheme is designed to include more sub-frames (e.g. 9 sub-frames) compared to sub-frames for a simple RTC scheme (e.g. 6 sub-frames) for a same duration of a frame (e.g. 16.67 ms per frame).

Furthermore, two additional waveforms for light transmittance levels (700(b)) over time show light transmittance ratios of realistic and commonly-used liquid crystal pixels (i.e. other than an exotic and expensive LCD technology such as OCB-type LCD's) at the first row-first column and the last row-last column, each pixel taking a even more substantially reduced transition time by using an advanced RTC scheme. In one embodiment of the invention, the advanced RTC scheme is configured to provide a voltage boost control for a Gamma (gray scale) reference voltage and/or a VCOM voltage on top of a simple RTC scheme described previously for FIG. 6, which over-boosts or under-boosts an RTC gray level command value by manipulating a pixel voltage using an RTC lookup table. The added voltage boost control for the Gamma (gray scale) reference voltage and/or the VCOM voltage accommodate fast black-to-white and white-to-black gray level transitions, whereas the simple RTC scheme mostly accelerates one gray-shade to another gray-shade transitions. A resulting benefit is even faster light transmittance level (i.e. gray level) transitions for pixels used in an FSLCD, as evidenced by even steeper downward and upward curves in light transmittance levels (700(b) using the advanced RTC scheme.

Continuing with FIG. 7, the primary-color LED emitting timings (700(c)) in FIG. 7 indicate LED lamp “on” timing for red, blue, or green LED as backlights in a FSLCD. In a preferred embodiment of the invention using the advanced RTC scheme as shown in FIG. 7, the LED “on” time is shorter than previous examples of FIG. 4˜6, requiring an LED backlight to be “on” for only 1.85 ms ( 1/9^{th} of a typical frame) instead of 2.78 ms (⅙^{th} of a typical frame). The finer subdivisions of a frame for emitting an LED backlight as illustrated by the advanced RTC scheme in FIG. 7 helps commonly-used and cost-effective conventional liquid crystals to satisfy a rigorous LED backlighting sequence timing requirement.

Assuming that display conditions were according to pixel voltages (700(a)), realistic pixel light transmittance levels (700(b)) with the advanced response time compensation (RTC) scheme, and primary-color LED emitting timings (700(c)) over a commonly-shared time period, the resulting display patterns (700(d)) relative to time for the FSLCD are sufficient to satisfy even a very rigorous example comparing color hues of a first row-first-column pixel to a last row-last column pixel in the FSLCD using a line scanning refresh method. The resulting display patterns (700(d)) clearly show correct plain yellow colors for both the first row-first column pixel and the last row-last column pixel to the human eye.

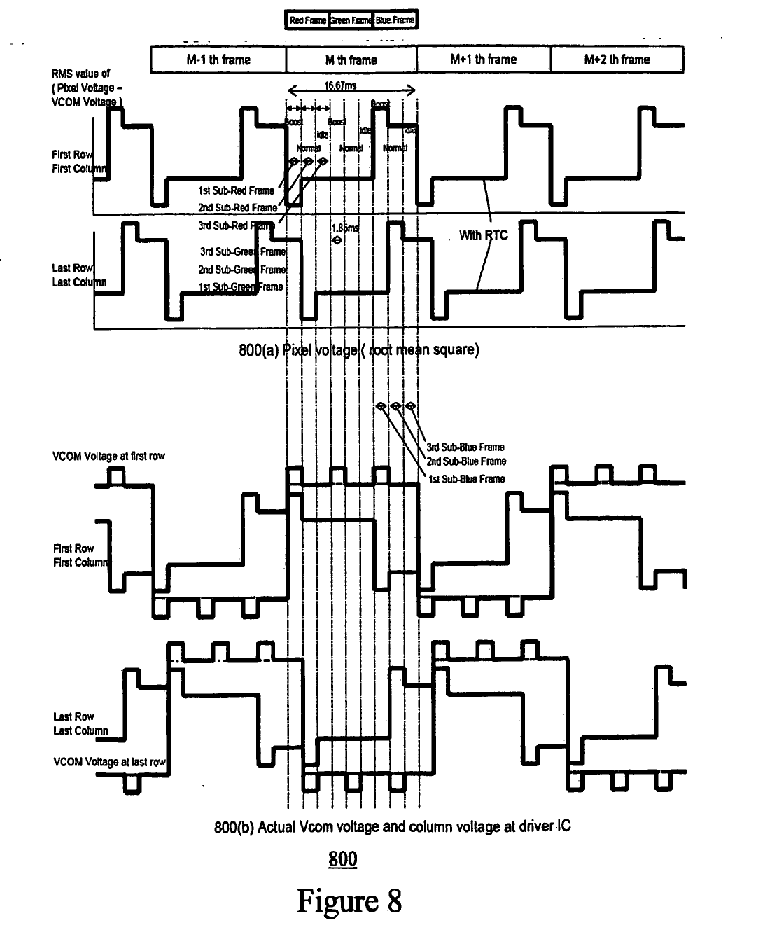

FIG. 8 shows an example (800) of root-mean-square pixel voltages (800(a)) and driver IC VCOM and column voltages (800(b)) relative to time when a yellow color is displayed on an FSLCD based on the example of FIG. 7, in accordance with an embodiment of the invention. In one embodiment of the invention, a duration of a VCOM voltage boost is 1.85 ms, if a frame is 16.67 ms and the number of sub-frames per frame is 9, as illustrated by FIG. 8.

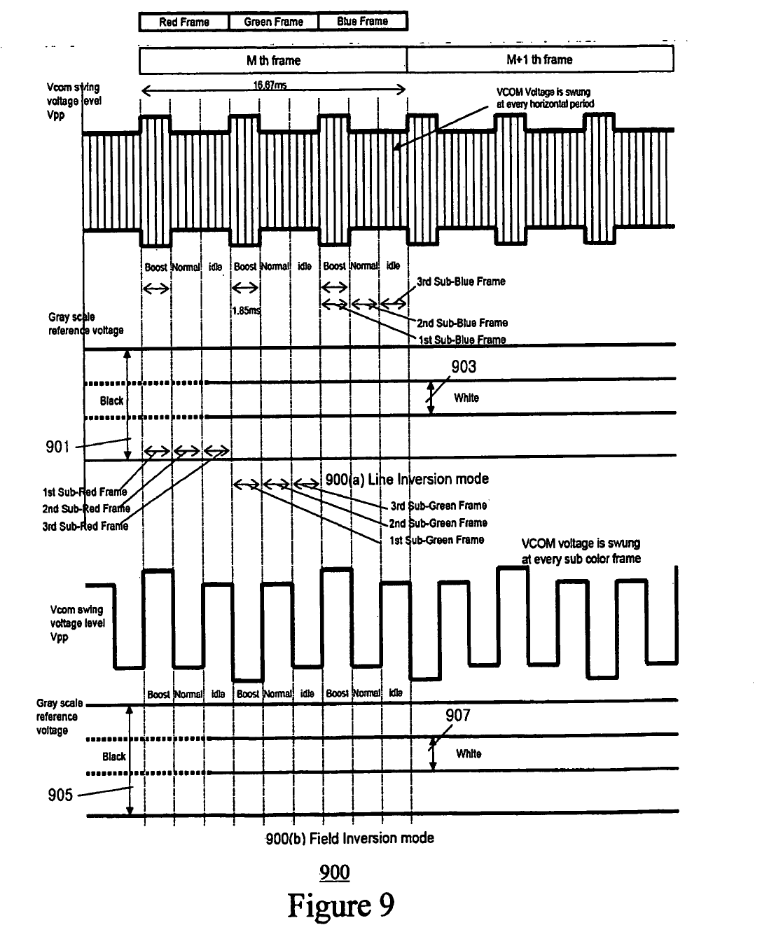

FIG. 9 shows an example (900) of various voltage levels in a field-sequential display (FSLCD) for a quick white-black transition using a line inversion mode (900(a)) or a field inversion mode (900(b)) in accordance with an embodiment of the invention. In the line inversion mode (900(a)), the VCOM swing voltage level waveforms show boosted VCOM peak-to-peak level swing voltage and gray scale reference voltages for black (901) and white (903) gray levels. The VCOM voltage is changed at every horizontal period (i.e. Hsync) and the gray scale voltage has a flat DC voltage level as shown in the line inversion mode (900(a)) example. In the field inversion mode (900(b)), the VCOM swing voltage level waveforms show boosted VCOM peak-to-peak level swing voltage and gray scale reference voltage, wherein the VCOM voltage can change polarity at every first, second, and third sub color frame or every color frame.

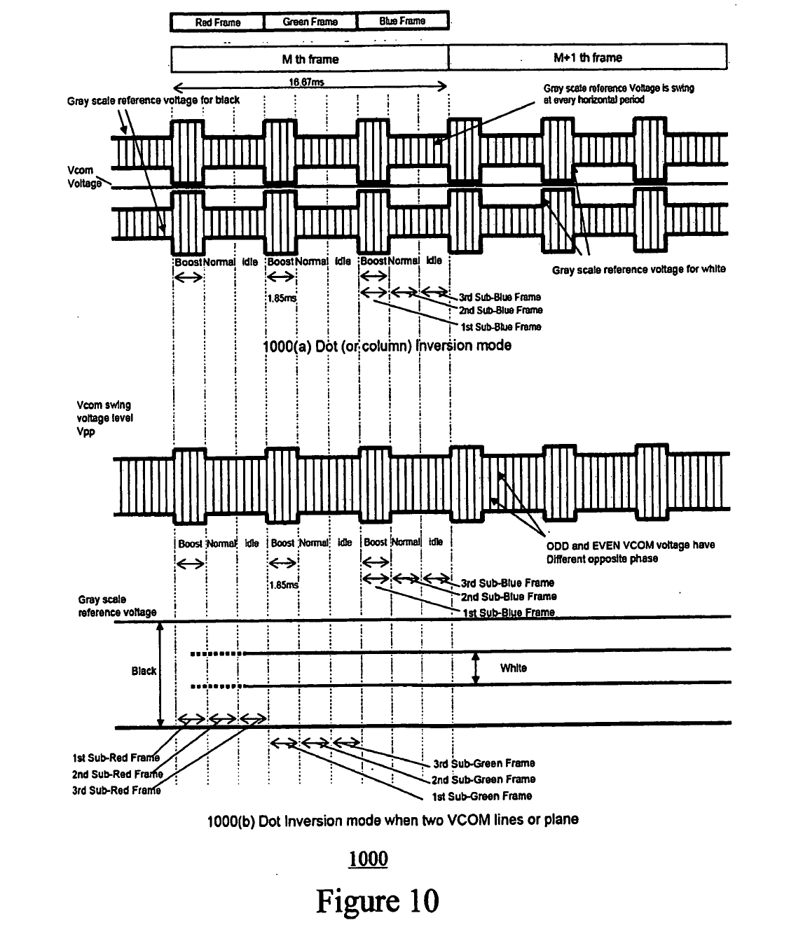

FIG. 10 shows various voltage levels in a field-sequential display (FSLCD) for a quick white-black transition using dot or column inversion modes (1000(a), 1000(b)) in accordance with an embodiment of the invention. In the dot or column inversion mode as shown in waveforms (1000(a)), the gray scale reference voltages have a voltage modulation during a VCOM's “boost” period (i.e. typically a first sub color frame) to reduce liquid crystal transition time for white-to-black and black-to-white gray level transitions. The lower waveforms (1000(b)) show boosted VCOM peak-to-peak level swing voltage if a dot inversion mode uses two VCOM electrodes to support voltage boosts without requiring a gray scale voltage generator to provide voltage boosts Exempting the gray scale voltage generator to provide voltage boosts can lower voltage for an underlying semiconductor. In the example of the lower waveforms (1000(b)), the voltage level of gray scale reference voltage for the dot inversion mode can be the same as the line inversion mode.

It should be noted that a first set (i.e. “Red Frame”) of three sub-frames for each frame (i.e. M th frame, M+1 th frame, and etc.) has “boost”, “normal”, and “idle” modes for a red LED. Furthermore, a second set (i.e. “Green Frame”) of three sub-frames for each frame (i.e. M th frame, M+1 th frame, and etc.) also has “boost”, “normal”, and “idle” modes for a green LED. In addition, the third set (i.e. “Blue Frame”) of three sub-frames for each frame (i.e. M th frame, M+1 th frame, and etc.) also has “boost”, “normal”, and “idle” modes for a blue LED. In one embodiment of the invention, the “boost” mode refers to a sub-frame in which a voltage boost and/or RTC can occur to a specific pixel. The “normal” mode refers to a sub-frame in which a non-RTC operation can occur in the FSLCD or a component operatively connected to the FSLCD. In addition, the “idle” mode refers to a sub-frame in which a liquid crystal pixel cell should remain stationary because a color LED backlight is applied to the liquid crystal pixel cell. In some implementations of the present invention, only two modes (i.e. “boost” and “normal” modes) may be repeated in sequence of “boost”→“normal”→“normal” for each set of the three sub-frames instead of “boost”→“normal”→“idle”, because skipping the “idle” mode and instead using the “normal” modes twice may be simpler to implement.

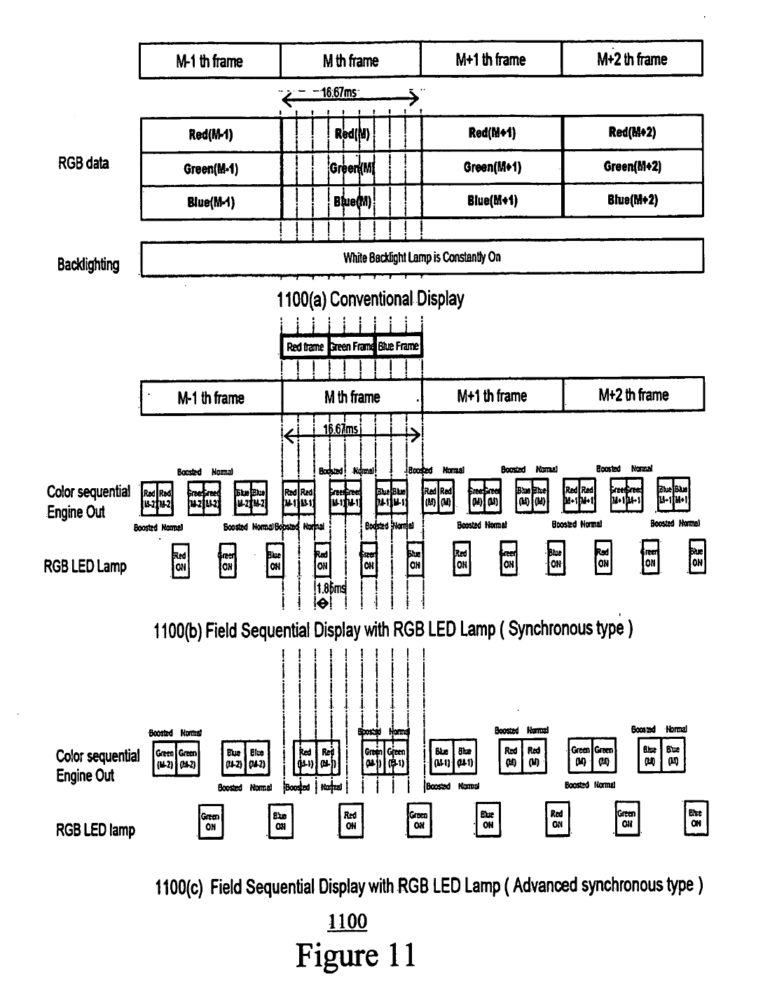

FIG. 11 shows a primary-color frame comparison among a conventional TFT LCD display with color filters (1100(a)), a synchronous-type field sequential display with primary color LED's (1100(b)) in accordance with an embodiment of the invention, and an advanced synchronous-type field sequential display with primary color LED's (1100(c)) in accordance with another embodiment of the invention. The conventional TFT LCD display with color filters (1100(a)) reserves a duration of one entire frame (e.g. 16.67 ms) to expose a sub-pixel corresponding to a particular primary color to a white backlight. In contrast, the synchronous-type field sequential LCD (FSLCD) with primary color LED's (1100(b)) divides a frame into a multiple number of sub-frames, each of which is reserved for a particular mode for a particular primary-color LED. Although the sub-frames are generally equal in length for a synchronous-type FSLCD mode, LED “on” times can be lengthened or shortened in some cases by manipulating sequential display data to achieve a desired brightness.

Continuing with FIG. 11, the advanced synchronous-type field sequential display with primary color LED's (1100(c)) is synchronized using real numbers instead of integer multiples to enable a flexible LED operating frequency and optimized response time compensation (RTC) in liquid crystal pixels.

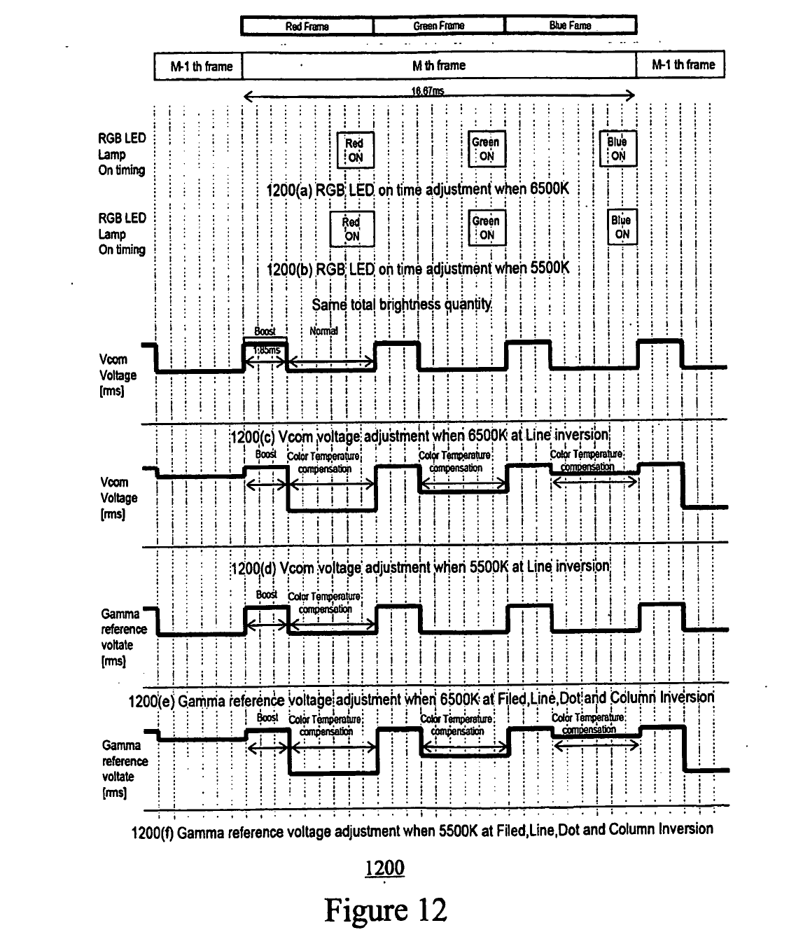

FIG. 12 shows an example (1200) of a temperature-dependent LED-emitting duration adjustment to keep a relatively consistent display brightness level at various ambient temperatures near LED backlights (i.e. also called “color temperatures”) in accordance with an embodiment of the invention. An RGB (i.e. primary colors) LED “on” time adjustment when the ambient temperature near the LED backlights is 6500K is shown in 1200(a), in contrast with the RGB LED “on” time adjustment when the ambient temperature near the LED backlights is 5500K in 1200(b). In one embodiment of the invention, the RGB LED “on” time is shortened at higher ambient temperatures. The objective of adjusting the LED-emitting duration is to maintain a relatively consistent brightness to a viewer regardless of changing ambient temperature conditions of the LED backlights during an operation of an FSLCD.

A waveform example of VCOM voltage adjustments at the ambient temperature of 6500K using a line inversion mode is shown in 1200(c), and a waveform example of VCOM voltage adjustments at the ambient temperature of 5500K using a line inversion mode is shown in 1200(d). Furthermore, a waveform example of Gamma reference voltage adjustment at the ambient temperature of 6500K using a file, line, dot, and/or column inversion modes is shown in 1200(e), and a waveform example of Gamma reference voltage adjustment at the ambient temperature of 5500K using a file, line, dot, and/or column inversion modes is shown in 1200(f).

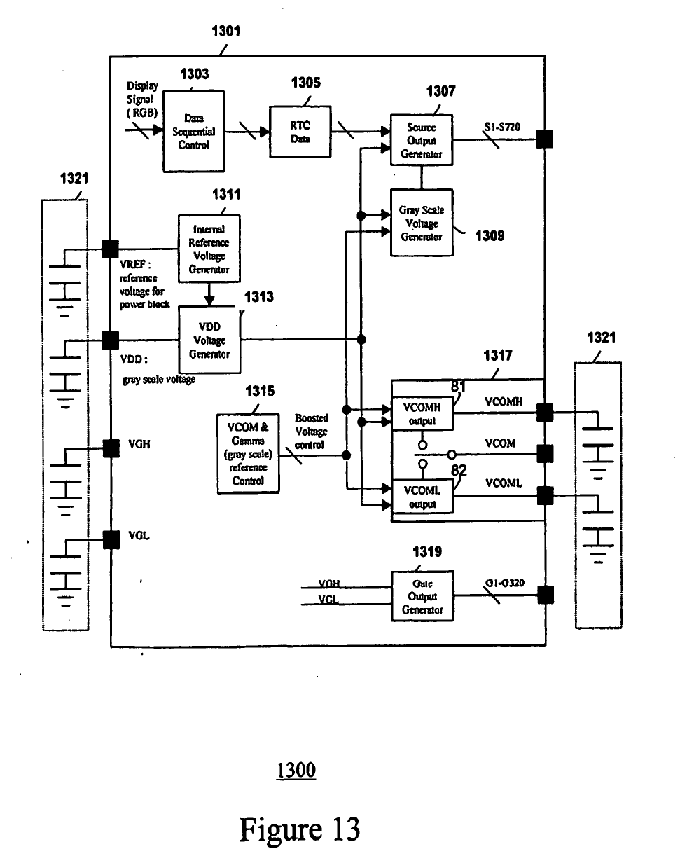

FIG. 13 shows an example of a logic block (1300) for a color sequential data and control signal generator (1301) containing a boosted VCOM and Gamma (i.e. gray scale) reference voltage control (1315), a data sequential control (1303), an RTC data block (1305), a VCOM output block (1317) comprising a VCOMH output block (81) and a VCOML output block (82), and generators (e.g. 1311, 1313, 1319) for a quarter-VGA (QVGA) application, in accordance with an embodiment of the invention. The VCOM and Gamma reference voltage control (1315) controls a gray scale voltage generator (1319) which is configured to generate a “boost” mode gray scale voltage or VCOM voltage at every first sub color frame, and a “normal” mode gray scale voltage or VCOM voltage on the next sub color frame. In one embodiment of the invention, the VCOM output block (1317) is grounded (1321) and a VDD voltage generator (1313) and an internal reference voltage generator (1311) are also grounded (1321).

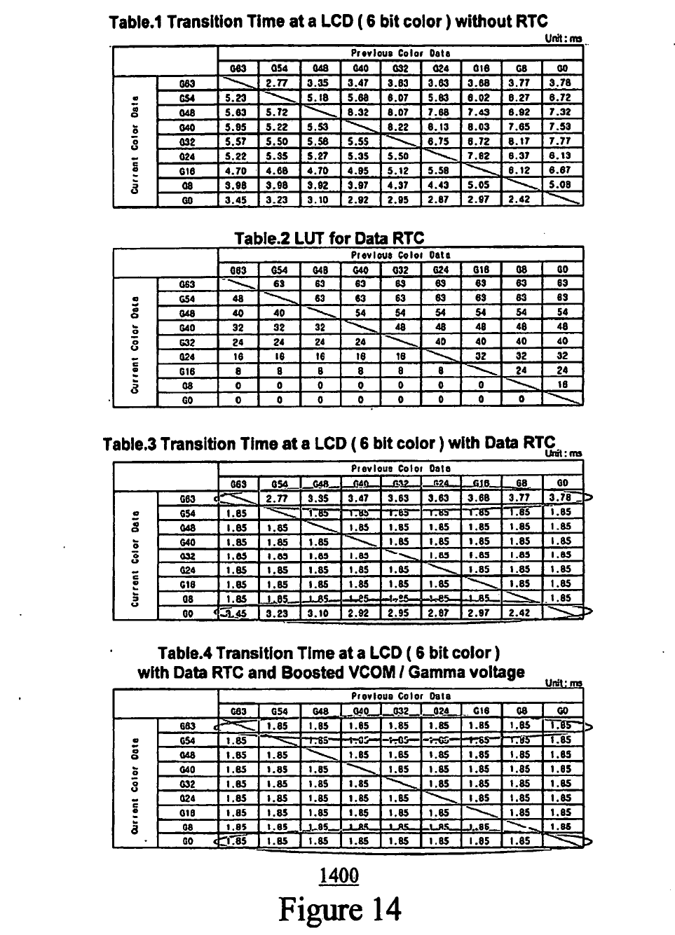

FIG. 14 contains Tables 1˜4 (1400). Table 1 shows an example of transition times for a 6-bit color LCD without any response time compensation (RTC). The transition time indicated here in milliseconds (ms) represent a full transition time of a liquid crystal cell from one gray level to another gray level. In addition, Table 2 shows an example of a lookup table (LUT) for data response time compensation (RTC) in accordance with an embodiment of the invention. In the LUT of Table 2, a previous gray level value (i.e. “Previous Color Data”) and a current gray level value (i.e. “Current Color Data”) can pinpoint an RTC gray level value for a particular liquid crystal pixel, wherein the RTC gray level value will accelerate transition time between one gray level to another by either under-boosting or over-boosting pixel voltage delivered to the particular liquid crystal pixel. In most implementations of lookup tables for RTC, empirical evidence and data which best expedites liquid crystal pixel transition times are used to provide entry to the lookup table.

Continuing with FIG. 14, Table 3 shows an example of transition times for a 6-bit color LCD with data response time compensation (RTC) in accordance with an embodiment of the invention. Table 4 shows an example of transition times for a 6-bit color LCD with data response time compensation (RTC) and boosted VCOM and Gamma voltages in accordance with an embodiment of the invention. With the addition of boosted VCOM and Gamma voltages, a black-to-a-mid-gray-level (e.g. G0→G40), a black-to-white gray level (e.g. G0→G63), and a white-to-black gray level (e.g. G63→G0) transition times are significantly shortened compared to a mere use of the RTC, which is previously illustrated in Table 3.

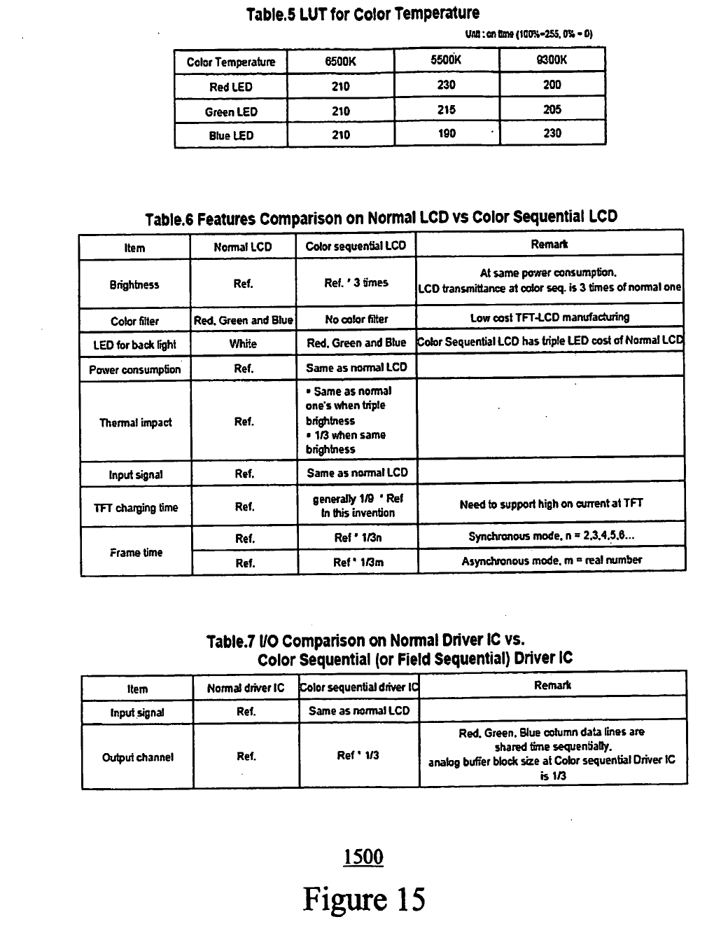

FIG. 15 contains Tables 5˜6 (1500). Table 5 shows an example of a lookup table (LUT) for LED lamp-emitting durations relative to various ambient temperatures near LED backlights (i.e. also called “color temperatures”) in accordance with an embodiment of the invention. By adjusting LED lamp-emitting durations relative to various ambient temperatures near the LED backlights, an FSLCD can maintain a relatively consistent brightness regardless of ambient temperature variations inside or near an LED lamp assembly. Table 6 shows some feature comparisons between a conventional color TFT LCD with color filters versus a field-sequential LCD (FSLCD) in accordance with an embodiment of the invention. Table 7 shows an input/output comparison between a conventional driver IC for a color TFT LCD with color filter s versus a field-sequential LCD (FSLCD) driver IC in accordance with an embodiment of the invention.

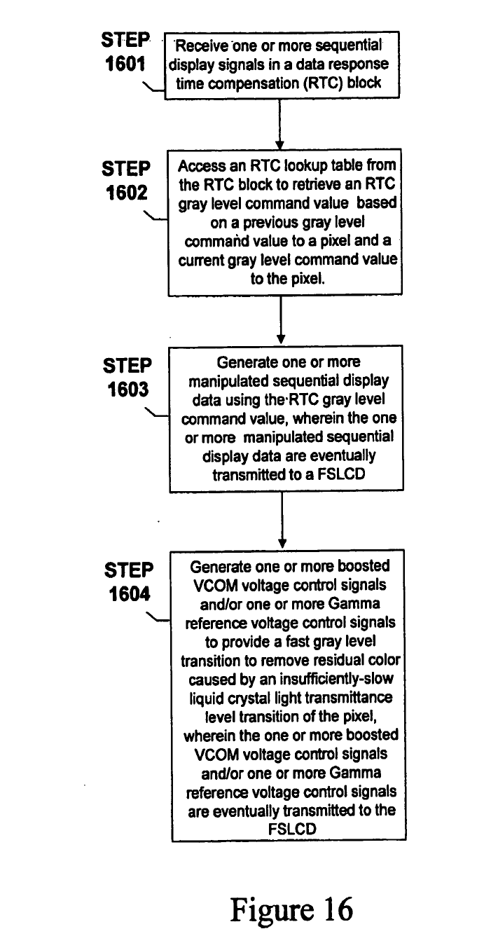

FIG. 16 shows a method for reducing erroneous color effects in a field sequential liquid crystal display (FSLCD) using an apparatus in accordance with an embodiment of the invention. In a preferred embodiment of the invention, the apparatus receives one or more sequential display signals in a data response time compensation (RTC) block, as shown in STEP 1601. Then, the apparatus accesses an RTC lookup table from the RTC block to retrieve an RTC gray level command value based on a previous gray level command value to a pixel and a current gray level command value to the pixel, as shown in STEP 1602. Then, the apparatus generates one or more manipulated sequential display data using the RTC gray level command value, wherein the one or more manipulated sequential display data are eventually transmitted to a FSLCD, as shown in STEP 1603. Then, as shown in STEP 1604, the apparatus can also generate one or more boosted VCOM voltage control signals and/or one or more Gamma reference voltage control signals to provide a fast gray level transition to remove residual color caused by an insufficiently-slow liquid crystal light transmittance level transition of the pixel, wherein the one or more boosted VCOM voltage control signals and/or one or more Gamma reference voltage control signals are eventually transmitted to the FSLCD.

The present invention provides several key benefits to designing a field-sequential LCD (FSLCD). One key benefit is making a slow-response-time liquid crystal materials compatible to a rigorous timing requirement of the FSLCD by achieving faster light transmittance level transitions of liquid crystal pixels. By using a unique response time compensation (RTC) scheme with a lookup table, boosted Gamma reference voltage and/or VCOM voltages to induce faster transitions of light transmittance levels, and finer subdivision of sub-frames in a frame to minimize erroneous color effects, the present invention enables the use of slow response time liquid crystal materials for FSLCD applications.

A further benefit of the present invention is making FSLCD's more cost-effective to manufacture by enabling the use of commonly-used and slow response liquid crystal technologies such as twisted nematic (TN), in-plane switching (IPS), vertical align (VA), and other variants in FSLCD applications without suffering erroneous color side effects caused by light transmittance level transition delays.

Yet another benefit of the present invention is achieving a relatively consistent display brightness to a human eye regardless of varying color temperatures of primary-color backlight LED's by using a lookup table to adjust a light-emitting duration of a particular primary-color LED depending on a current color temperature.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus for reducing an erroneous color effect in a field-sequential liquid crystal display (FSLCD), the apparatus comprising:
a data response time compensation (RTC) block configured to receive sequential display signals, wherein the data RTC block is also configured to use an RTC lookup table to provide a fast transition response time from one gray level to another gray level for a liquid crystal pixel cell by using a response time compensation (RTC) scheme during a color LED backlighting sequence;
a VCOM and Gamma reference control block configured to generate a voltage boost and provide boost control to the liquid crystal pixel cell in a FSLCD panel operatively connected to the VCOM and Gamma reference control block, wherein the voltage boost gives a fast gray level transition to remove residual color caused by a slow transition time between liquid crystal light transmittance levels for the liquid crystal pixel cell; and
an output interface for the RTC block and/or the VCOM and Gamma reference control block, wherein the output interface is configured to transmit manipulated sequential display data from the RTC block and/or the output interface is configured to transmit a boosted voltage control signal from the VCOM and Gamma reference control block.

2. The apparatus of claim 1, further comprising an LED control block configured to coordinate and/or control the color LED backlighting sequence, wherein the color LED backlighting sequence typically involves at least three primary-color LED's, including a red LED, a green LED, and a blue LED.

3. The apparatus of claim 2, wherein the LED control block is further configured to use a color temperature lookup table block for an LED-emitting duration adjustment based on an ambient temperature near one or more LED's operatively connected to the apparatus.

4. The apparatus of claim 3, wherein the LED-emitting duration adjustment based on the ambient temperature near the one or more LED's is configured to provide a relatively consistent brightness to the FSLCD regardless of ambient temperature variations near the one or more LED's.

5. The apparatus of claim 1, further comprising a timing control block configured to receive one or more external control signals and generate one or more internal timing control signals for the apparatus.

6. The apparatus of claim 2, further comprising a data sequential control block configured to receive display signal data and generate sequential color display data categorized by each frame and/or sub-frames of each frame, wherein each frame comprises 9 sub-frames and each sub-frame is a sub color frame associated with the red LED, the green LED, or the blue LED.

7. The apparatus of claim 1, wherein the apparatus is integrated into a display driver integrated circuit (IC).

8. The apparatus of claim 1, wherein the apparatus is integrated into a flexible printed circuit (FPC) operatively connected to a field-sequential LCD display panel.

9. The apparatus of claim 1, wherein the apparatus is integrated into a mobile electronic device to control the FSLCD operatively connected to the mobile electronic device.

10. The apparatus of claim 1, wherein the erroneous color effect is defined as a color variance from a desired color, a color distortion from the desired color, and/or a non-uniform color to a human eye exposed to the color LED backlighting sequence of the FSLCD.

11. The apparatus of claim 1, wherein the RTC scheme uses an RTC gray level command value retrieved from the RTC lookup table based on a previous gray level command value and a current gray level command value.

12. The apparatus of claim 11, wherein the RTC gray level command value from the RTC lookup table either over-boosts or under-boosts a next gray level command value based on empirical data specific to the apparatus and the FSLCD to achieve the fast transition response time for the liquid crystal pixel cell.

13. An apparatus for reducing an erroneous color effect in a field-sequential liquid crystal display (FSLCD), the apparatus comprising:
a data response time compensation (RTC) block configured to receive sequential display signals, wherein the data RTC block is also configured to use an RTC lookup table to provide a fast transition response time from one gray level to another gray level for a liquid crystal pixel cell by using a response time compensation (RTC) scheme during a color LED backlighting sequence; and
an output interface for the RTC block, wherein the output interface is configured to transmit manipulated sequential display data from the RTC block.

14. The apparatus of claim 13, further comprising a VCOM and Gamma reference control block configured to generate a voltage boost and provide boost control to the liquid crystal pixel cell in a FSLCD panel operatively connected to the VCOM and Gamma reference control block, wherein the voltage boost gives a fast gray level transition to remove residual color caused by a slow transition time between liquid crystal light transmittance levels for the liquid crystal pixel cell.

15. The apparatus of claim 13, further comprising an LED control block configured to coordinate and/or control the color LED backlighting sequence, wherein the color LED backlighting sequence typically involves at least three primary-color LED's, including a red LED, a green LED, and a blue LED.

16. The apparatus of claim 11, wherein the apparatus is integrated into a display driver integrated circuit (IC).

17. The apparatus of claim 11, wherein the apparatus is integrated into a flexible printed circuit (FPC) operatively connected to a field-sequential LCD display panel.

18. The apparatus of claim 11, wherein the apparatus is integrated into a mobile electronic device to control the FSLCD operatively connected to the mobile electronic device.

19. The apparatus of claim 11, wherein the erroneous color effect is defined as a color variance from a desired color, a color distortion from the desired color, and/or a non-uniform color to a human eye exposed to the color LED backlighting sequence of the FSLCD.

20. A method for reducing an erroneous color effect in a field-sequential liquid crystal display (FSLCD), the method comprising steps of:
receiving one or more sequential display signals in a data response time compensation (RTC) block;
accessing an RTC lookup table from the RTC block to retrieve an RTC gray level command value based on a previous gray level command value to a pixel and a current gray level command value to the pixel;
generating one or more manipulated sequential display data using the RTC gray level command value, wherein the one or more manipulated sequential display data are eventually transmitted to the FSLCD; and
generating one or more boosted VCOM voltage control signals and/or one or more Gamma reference voltage control signals to provide a fast gray level transition to remove residual color caused by an insufficiently-slow liquid crystal light transmittance level transition of the pixel, wherein the one or more boosted VCOM voltage control signals and/or one or more Gamma reference voltage control signals are eventually transmitted to the FSLCD.
